(19) United States
(12) Patent Application Publication
(10) Pub. No.: US 2015/0295391 A1
(43) Pub. Date: Oct. 15, 2015

(54) Stripper

(71) Applicant: HANLONG INDUSTRIAL CO., LTD., New Taipei City (TW)

(72) Inventors: Chien-Chou Liao, Tu Cheng City (TW); Wan-Yu Chiang, Tu Cheng City (TW)

(21) Appl. No.: 14/299,013

(22) Filed: Jun. 9, 2014

(30) Foreign Application Priority Data
Apr. 15, 2014 (TW) 103206489

(51) Int. Cl. H02G 1/12; H01R 43/042

(52) U.S. Cl. CPC H02G 1/1214; H01R 43/0421

(57) ABSTRACT

A stripper is disclosed. The stripper includes a pair of plier bodies and at least one pair of blades. The two plier bodies are pivotally connected to each other. Each plier body includes a cutting part and a stripping part, wherein the cutting parts of the pair of plier bodies are used for cutting a wire, and one side of each of the stripping parts includes at least one plier body notch. The plier body notches are used for forming an opening for containing the wire when the pair of plier bodies are clamped. The at least one pair of blades are respectively removably connected to the stripping parts of each of the plier bodies, and the two blades are used for removing at least one covering layer of the wire.

### BACKGROUND OF THE INVENTION

1. Field of the Invention

The present invention relates to a stripper; more particularly, the present invention relates to a stripper used for cutting a coaxial cable and stripping the covering layer around the coaxial cable.

2. Description of the Related Art

Since the structure of the coaxial cable is special, the tool for cutting the coaxial cable is able not only to cut the wire but also to strip the outer covering layer. Although the stripper tool of the prior art has the function of cutting and stripping the wire, the blade of the stripper tool for stripping is limited by its position, such that the blade is hard to sharpen. If the blade becomes blunt, it will cost great effort and time to use the stripper tool for stripping.

Therefore, there is a need to provide a new stripper to solve the disadvantage of the prior art.

### SUMMARY OF THE INVENTION

It is an object of the present invention to provide a stripper that has a replaceable blade for stripping a covering layer of a wire.

To achieve the abovementioned object, the stripper of the present invention includes a pair of plier bodies and at least one pair of blades. The two plier bodies are pivotally connected to each other. Each plier body includes a cutting part and a stripping part, wherein the cutting part of the pair of plier bodies is used for cutting a wire, and one side of each of the stripping parts includes at least one plier body notch. The plier body notches are used for forming an opening for containing the wire when the pair of plier bodies are clamped. The at least one pair of blades are respectively demountably connected to the stripping parts of each of the plier bodies, and the two blades are used for stripping at least one covering layer of the wire.

According to one embodiment of the present invention, the stripper of the present invention further includes a pair of covers. The pair of covers are respectively connected to the stripping part of each of the plier bodies for covering each of the blades.

According to one embodiment of the present invention, at least one of the pair of covers includes at least one bump, and the at least one bump has a function of indicating a length of the at least one covering layer of the wire to be stripped.

According to one embodiment of the present invention, each side of the pair of covers respectively includes at least one cover notch. The at least one pair of cover notches are used for forming an opening for containing the wire when the pair of covers are combined with each of the plier bodies and the pair of plier bodies are clamped.

According to one embodiment of the present invention, the pair of covers are demountably combined with the stripping part of each of the plier bodies, respectively.

According to one embodiment of the present invention, the cutting part includes at least two cutting surfaces of different sharpness.

According to one embodiment of the present invention, the cutting part includes an upper cutting surface, a lower cutting surface, and a concave corner. The sharpness of the upper cutting surface and the sharpness of the lower cutting surface are greater than the sharpness of the concave corner.

According to one embodiment of the present invention, the stripping part of each of the plier bodies includes a groove. Each of the grooves is used for containing each of the blades.

According to one embodiment of the present invention, each of the plier bodies further includes a crimping part. Each of the crimping parts is connected to each of the cutting parts. The two crimping parts are used for laminating a terminator to one end of the wire via clamping of the pair of plier bodies.

According to one embodiment of the present invention, the stripper of the present invention further includes a pair of sheathings. Each of the plier bodies further includes a gripping part. Each of the gripping parts is connected to each of the stripping parts, and the pair of sheathings are respectively used for covering the gripping part of each of the plier bodies.

### BRIEF DESCRIPTION OF THE DRAWINGS

The exemplary embodiment(s) of the present invention will be understood more fully from the detailed description given below and from the accompanying drawings of various embodiments of the invention, which, however, should not be taken to limit the invention to the specific embodiments, but are for explanation and understanding only.

FIG. 1 illustrates a top view of the plier body of the stripper of the present invention when stripping the cover.

FIG. 2 illustrates a top view of the plier body of the stripper of the present invention when not stripping the cover.

FIG. 3 illustrates an exploded perspective view of the stripper of the present invention.

FIG. 4 illustrates an enlarged schematic drawing of the cutting part of the stripper of the present invention.

FIG. 5 illustrates an enlarged schematic drawing of the stripping part of the stripper of the present invention.

FIG. 6 illustrates a schematic drawing of the stripping part of the stripper of the present invention when stripping the cover.

### DETAILED DESCRIPTION OF THE PREFERRED EMBODIMENT

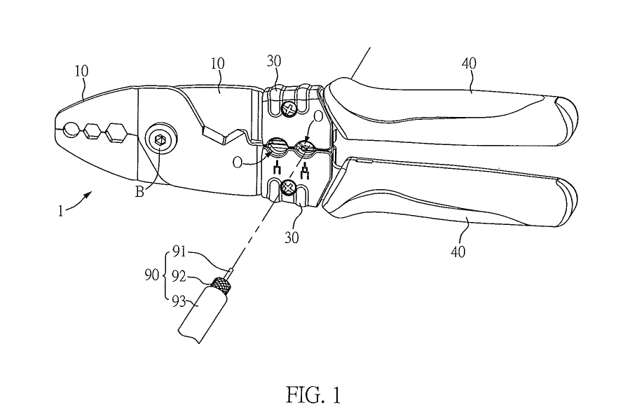

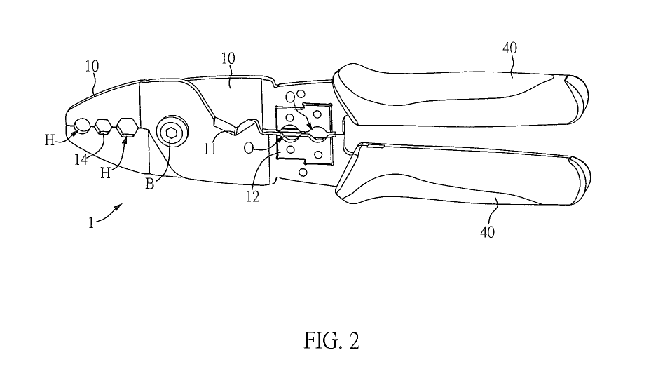

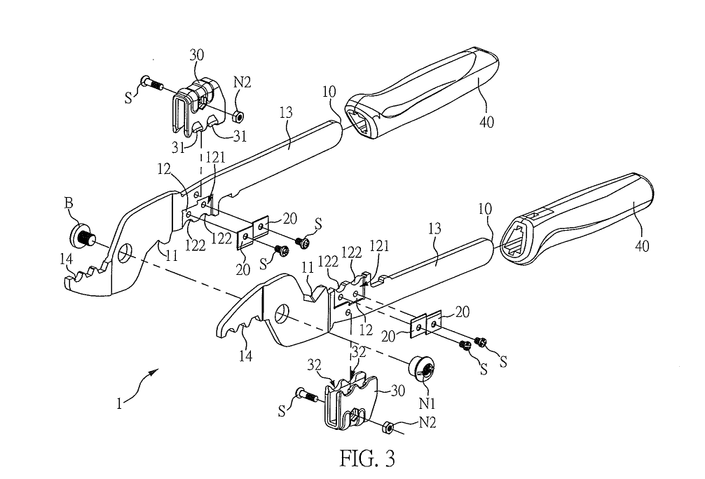

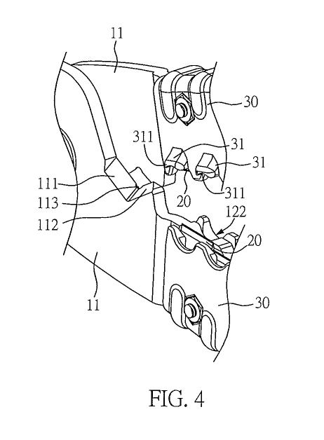

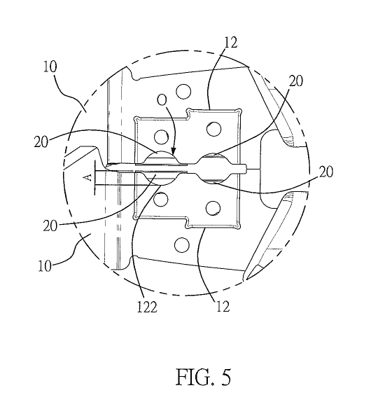

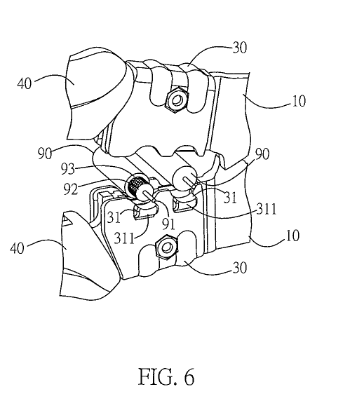

Please refer to FIG. 1 to FIG. 6. FIG. 1 illustrates a top view of the plier body of the stripper of the present invention when stripping the cover; FIG. 2 illustrates a top view of the plier body of the stripper of the present invention when not stripping the cover; FIG. 3 illustrates an exploded perspective view of the stripper of the present invention; FIG. 4 illustrates an enlarged schematic drawing of the cutting part of the stripper of the present invention; FIG. 5 illustrates an enlarged schematic drawing of the stripping part of the stripper of the present invention; FIG. 6 illustrates a schematic drawing of the stripping part of the stripper of the present invention when stripping the cover.

As shown in FIG. 1, in one embodiment of the present invention, the stripper 1 of the present invention is used for cutting a wire 90. The wire 90 includes a central copper wire 91 and two covering layers 92, 93, which surround the central copper wire 91. In one embodiment of the present invention, the wire 90 is a coaxial cable, but the present invention is not limited to that design.

As shown in FIG. 2 and FIG. 3, in one embodiment of the present invention, the stripper 1 includes a pair of plier bodies 10, two pairs of blades 20, a pair of covers 30, and a pair of sheathings 40.

The two plier bodies 10 are pivotally connected to each other via locking of the bolt B and the nut N1. Each of the plier bodies 10 includes a cutting part 11, a stripping part 12, a gripping part 13, and a crimping part 14.

As shown in FIG. 1, FIG. 3, and FIG. 4, in one embodiment of the present invention, the cutting parts 11 of the two plier bodies 10 are used for cutting the wire 90, wherein each cutting part 11 includes an upper cutting surface 111, a lower cutting surface 112, and a concave corner 113. The upper cutting surface 111 is connected to the lower cutting surface 112, the concave corner 113 is located at the position where the upper cutting surface 111 is connected to the lower cutting surface 112, and the concave corner 113 is substantially arc-shaped. The sharpness of the upper cutting surface 111 and the sharpness of the lower cutting surface 112 are greater than the sharpness of the concave corner 113, which means that the cutting parts 11 have two cutting surfaces of different sharpness. Therefore, when the user uses the stripper 1 to cut the wire 90, since the upper cutting surface 111 and the lower cutting surface 113 are very sharp, the upper cutting surface 111 and the lower cutting surface 113 are suitable for cutting the soft covering layers 92, 93; the concave corner 113 is not very sharp and the cutting edge angle of the concave corner 113 is large, such that the concave corner 113 is suitable for cutting the hard central copper wire 91 to prevent damage to the cutting surface.

As shown in FIG. 2 and FIG. 3, in one embodiment of the present invention, the stripping part 12 and the cutting part 11 of the plier body 10 are connected. The stripping parts 12 of the two plier bodies 10 respectively include a groove 121 for containing the blade 20. One side of the stripping part 12 of the two plier bodies 10 respectively includes two plier body notches 122, and the two plier body notches 122 of one plier body 10 are corresponded to the two plier body notches 122 of the other plier body 10. The corresponding plier body notches 122 are used for forming an opening O for containing the wire 90 when the pair of plier bodies 10 are clamped. The sizes of the two openings O formed by the corresponding plier body notches 122 are different.

The gripping part 13 of the plier body 10 is connected to the stripping part 12, and the gripping part 13 is provided for the user to hold the stripper.

The crimping part 14 and the cutting part 11 of the plier body 10 are connected. The crimping part 14 of the pair of plier body 10 is used for laminating a terminator (not shown in the figure) to the wire 90 via clamping of the pair of plier bodies 10, causing the terminator to be combined with one end of the wire 90. When the plier bodies 10 are clamped, the crimping part 14 of the two plier bodies 10 can form a plurality of holes H of different sizes or shapes; each of the holes H is used for fitting terminators of different cross-sectional shapes and sizes.

As shown in FIG. 3 and FIG. 5, the two pairs of blades 20 are corresponded to each other; via locking of the screw S, the blades 20 are demountably connected to the groove 121 of the stripping part 12 of the two plier bodies 10, and the blades 20 respectively overlay each of the plier body notches 122. The pair of blades 20, which overlay the two plier body notches 122 that form the smaller opening, are used for stripping the two covering layers 92, 93; the pair of blades 20, which overlay to the two plier body notches 122 that form the larger opening, are used for stripping the outermost covering layer 93. As shown in FIG. 5, when the blades 20 overlay the stripping part 12 of the plier body 10, the greatest length between the edge of the blade 20 and the plier body notch 122 is a stationary size A, and the stationary size A can be the public regulation thickness of the coaxial cable when stripping; therefore, via the blocking of the plier body notch 122, the blade 20 can precisely cut the covering layers 92, 93 of a certain thickness to provide the function of precisely stripping the cable.

As shown in FIG. 3 and FIG. 6, in one embodiment of the present invention, the two covers 30 are demountably combined with the stripping part 12 of each of the plier bodies 10 via locking of the screw S and the nut N2. The covers 30 are used for covering each of the blades 20 to protect the user from being injured by the blade 20. The cover 30 includes a bump 31 and a cover notch 32, wherein there is a specific length between the edge of the blade 20 and an upper surface 311 of the bump 31, such as 6.35 mm. Therefore, when the user aligns one end of the wire 90 to the upper surface 311 of the bump 31 for executing the stripping, the covering layers 92 or 93 of a specific length will be removed; this means that the bump 31 can be used for indicating the length of the covering layers 92 or 93 of the wire 90 is stripped, such that the user can quickly and conveniently strip a predetermined length of the covering layers 92 or 93. As shown in FIG. 1 and FIG. 2, after the pair of covers 30 are combined with each of the plier bodies 10, and the pair of plier bodies 10 are clamped, the cover notches 32 form an opening O for containing the wire 90.

The pair of sheathings 40 are respectively used for covering the gripping part 13 of each of the plier bodies 10, such that the user may hold the gripping part 13 of the plier body 10 more comfortably, allowing the gripping part 13 to meet the principles of ergonomic design.

When the user uses the stripper 1 to cut the wire 90, first, the user can use the cutting part 11 of the plier body 10 to cut one end of the wire 90, and then the user can put the end of the cutting part of the wire 90 on the plier body notches 122 that form the smaller opening O. After the two plier bodies 10 are clamped, the user can slightly rotate the stripper 1 clockwise and counterclockwise around the wire 90 to cut and separate the two covering layers 92, 93. After the covering layers 92,39 are separated from the cable, the user can move the plier body 10 to the end of the wire 90 (during the motion, the plier body 10 is still clamped), such that the two covering layers 92, 93 will be removed by the blade 20 which overlays the plier body notches 122 that form the smaller opening O (as shown in the wire 90 on the right side in FIG. 6). Finally, the user can put one end of the wire 90 with the exposed central copper wire 91 on the plier body notches 122 that form the larger opening O, and the user can cause the two plier bodies 10 to clamp; via the same abovementioned operation method, the user can cut the covering layers 92. At this moment, because the perimeter of the opening O formed by the plier body notches 122 is greater than the perimeter of the covering layers 92, only the outermost covering layer 93 (as shown in the wire 90 on the left side in FIG. 6) will be removed.

The blade 20 of the stripper 1 of the present invention used for stripping the covering layers 92, 93 of the wire 90 is demountably connected to the stripping part of the plier body 10; therefore, if the blade 20 becomes blunt, the user needs only to replace the old blade 20 with a new blade 20. Therefore, the problem of the prior that a blunt blade makes a tool permanently hard to use can be solved. In addition, because the cutting part 11 of the plier body 10 includes the concave corner 113 of low sharpness, damage to the cutting surface is prevented when a central copper wire 91 made of hard material is cut, such that the operational life of the stripper 1 is increased.

It is noted that the above-mentioned embodiments are only for illustration. It is intended that the present invention cover modifications and variations of this invention provided they fall within the scope of the following claims and their equivalents. Therefore, it will be apparent to those skilled in the art that various modifications and variations can be made to the structure of the present invention without departing from the scope or spirit of the invention.

What is claimed is:

1. A stripper, comprising:
a pair of plier bodies, pivotally connected to each other, each of the pair of the plier bodies comprising a cutting part and a stripping part, wherein the pair of cutting parts are used for cutting a wire, each side of the stripping part comprising at least one plier body notch, the at least one pair of plier body notches are used for forming an opening for containing the wire when the pair of plier bodies are clamped; and
at least one pair of blades, respectively demountably connected to each of the stripping parts, used for stripping at least one covering layer of the wire.

2. The stripper as claimed in claim 1, further comprising a pair of covers, wherein the pair of covers are respectively connected to the stripping part of each of the plier bodies for covering each of the blades.

3. The stripper as claimed in claim 2, wherein at least one of the pair of covers comprises at least one bump, the at least one bump having a function of indicating the length of the at least one covering layer of the wire to be stripped.

4. The stripper as claimed in claim 2, wherein each side of the pair of covers respectively comprises at least one cover notch, and the at least one pair of cover notches are used for forming an opening for containing the wire when the pair of covers are respectively combined with each of the plier bodies and the pair of plier bodies are clamped.

5. The stripper as claimed in claim 2, wherein the pair of covers are demountably combined with the stripping part of each of the plier bodies.

6. The stripper as claimed in claim 1, wherein the cutting part comprises at least two cutting surfaces of different sharpness.

7. The stripper as claimed in claim 6, wherein the cutting part comprises an upper cutting surface, a lower cutting surface, and a concave corner, the sharpness of the upper cutting surface and the sharpness of the lower cutting surface being greater than a sharpness of the concave corner.

8. The stripper as claimed in claim 1, wherein each of the plier bodies comprises a groove, and each of the grooves is used for containing each of the blades.

9. The stripper as claimed in claim 1, wherein each of the plier bodies further comprises a crimping part, each of the crimping parts being connected to each of the cutting parts, and the two crimping parts are used for laminating a terminator to one end of the wire via clamping of the pair of plier bodies.

10. The stripper as claimed in claim 1, further comprising a pair of sheathings, and each of the plier bodies further comprising a gripping part, wherein each of the gripping parts is connected to each of the stripping parts, and the pair of sheathings are respectively used for covering the gripping part of each of the plier bodies.
